(19) United States
(12) Patent Application Publication
(10) Pub. No.: US 2001/0005521 A1
(43) Pub. Date: Jun. 28, 2001

(54) Power grain processing method and apparatus

(76) Inventors: Narimichi Takei, Tokyo (JP); Takehiko Itou, Tokyo (JP); Takuya Nakamura, Tokyo (JP); Kazuomi Unosawa, Tokyo (JP)

Correspondence Address: McCORMICK, PAULDING & HUBER LLP, CityPlace II, 185 Asylum Street, Hartford, CT, 06103-4102, US

(21) Appl. No.: 09/747,269

(22) Filed: Dec. 21, 2000

(30) Foreign Application Priority Data
Dec. 28, 1999 (JP) 11-372067

(51) Int. Cl. A23B 4/00

(52) U.S. Cl. 426/302; 426/518; 426/519

(57) ABSTRACT

A powder grain processing apparatus is provided such that both agitation and mixture of powder grains can be performed efficiently.

A powder grain processing apparatus has a rotary vessel for accommodating powder grains and a ventilation part provided with a circumferential wall of the rotary vessel, wherein an agitation means 4 is provided in the rotary vessel, and agitation parts 4a of agitation means 4 are a casing formed by surfaces through which the powder grains is incapable of passing, or a casing having at least an opening part in a part of the surfaces, in at least an upper surface side of the agitation parts 4a and a front side relative to a rotary direction of the rotary vessel.

### BACKGROUND OF THE INVENTION

The present invention relates to a powder grain processing technique and particularly to a powder grain processing technique which is effective for applying to the granulating, coating, mixing, drying or the like of medicines, food products and the like.

A so-called pan-coating apparatus is used as an apparatus for coating medicines and food products such as tablets and the like. In many cases, an agitation means is provided to agitate and mix efficiently tablets or the like accommodated in this apparatus and thereby to carry out uniform coatings.

An agitation means which is generally used serves to fix a so-called baffle and let the baffle stand on an inner wall of a vessel of a coating drum, as described in Japanese Utility Model Application Laid-open No. 56-7569, for example. The baffle thus fixed at the drum creates dead spaces near a back surface of the baffle relative to a rotary direction of the drum, so that coating liquid, and powders generated by abrasion of tablets or the like, and the like are easily collected in the vessel. This results from problems with respect to GMP (Good Manufacturing Practice). In addition, since the baffle cannot be replaced during operation, there is a drawback that the baffle cannot be constantly maintained to obtain an optimal agitation effect as volume of contents in the vessel greatly changes in accordance with progress of coating operation, for example, in case of sugar-coating or the like.

Also known is a type of structure in which the baffle is not fixed to a coating vessel but is inserted into the vessel from an outside thereof. Although Japanese Patent Publication No. 52-10665 discloses an obstacle generated in this type, this baffle is applied to an inclined type of circular vessel therein, so that it is impossible to obtain frequently good agitation effect in this type because contents in the vessel slip on an inner surface of the vessel. Further, Japanese Patent Application Laid-open No. 3-42028, No. 2-56232 and No. 7-116227, respectively, disclose an apparatus in which a baffle is inserted into a polygonal pan with a horizontal axis from an outside thereof. Also, the above-mentioned references disclose that an optimal position of the baffle is changed on the basis of an amount of contents therein.

Meanwhile, Japanese Utility Model Application Laid-open No. 51-25694 and Japanese Patent Application Laid-open No. 2-56233, No. 3-42028, and No. 7-116227, respectively, disclose an apparatus in which a circumferential wall of a rotary vessel has a porous structure and heated gas or the like is supplied or exhausted through the circumferential wall having the porous structure. Also, in these apparatuses, supplying or exhausting the heated air or the like into or from the rotary vessel is carried out by using a gas transport pipe or a duct.

On the other hand, Japanese Patent Publication No. 56-21454 and No. 52-19341 and Japanese Patent Application Laid-open No. 5-237170, No. 9-66227 and the like, respectively, disclose an apparatus in which a gas transport pipe is inserted into a pan from an outside thereof and supplying or exhausting gas is performed.

Since the above-mentioned apparatus inserting the baffle from the outside of the vessel solves a drawback that another apparatus has in which a baffle is installed on an inner wall of a vessel, the apparatus cannot have enough agitation effect to be satisfied. Moreover, an apparatus in which two plate-like objects are combined with each other in an inverted V-shape as disclosed in the Japanese Patent Publication No. 52-10665 has, in addition to the drawback described above, a problem that attached objects are accumulated in a rear side of the pan in a rotary direction of the pan.

Meanwhile, the Japanese Utility Model Application Laid-open No. 51-25694, Japanese Patent Publication No. 52-19341, and the Japanese Patent Application Laid-open No. 5-237170 and No. 9-66227 and the like, respectively, disclose the apparatus in which, as apparently shown in drawings thereof, each of a gas transport pipe and a blowing pipe has a shape and installation angle that do not interfere with flow of contents therein. Such apparatus, therefore, is not one that can be intended to attain agitation effect of the contents. Japanese Utility Model Application Laid-open No. 51-25694 (page 4 in specification of Japanese Utility Model Application No. 49-98404) discloses “Thus, if the gas transport pipe 2 having a curved top end is inserted in a group A of tablets which are rolling, the group A of tablets is agitated much more because it becomes an obstacle . . . ” However, this kind of gas transport pipe or blowing pipe cannot perform a satisfactory agitation effect.

Further, if a gas transport pipe for supplying and exhausting heated air and an agitation means for agitating and mixing a powder grain layer are provided together at the conventional apparatuses described above, there causes a problem as follows: since the apparatuses do not have enough spaces to locate both the gas transport pipe and the agitation means together, the gas transport pipe can not be inserted into the powder grain layer in some cases, and/or the agitation means can not be set in the other cases. In addition, there is a problem that if both are provided together, an inside of the rotary vessel is so narrow that an area, in which a coating liquid is sprayed from a spray nozzle, is narrowed much and/or can not be obtained as be desired.

It may be considered that such a problem is overcome by providing a supply part for supplying air, with a part which is out of contact with the powder grain layer. However, loss is caused before the supplied air reaches the powder grain layer and thereby there is a drawback that energy efficiency decreases.

In addition, the conventional apparatuses described above have problems that the coating liquid attaches to the gas transport pipe and/or the agitation means and thereby coating efficiency decreases.

Further, there can also happens another problem that, after coating material attaching to the gas transport pipe is solidified, the solidified coating material is peeled off therefrom, the peeled coating material falls down and mixes in granulation coating products, so that quality of the granulation coating products is decreased.

### SUMMARY OF THE INVENTION

An object of the present invention is to provide a powder grain processing technique capable of efficiently agitating and mixing powder grains being processed.

Another object of the present invention is to provide a powder grain processing technique capable of obtaining a large spray area in a rotary vessel.

Still another object of the present invention is to provide a technique capable of having good agitating and mixing effects on powder grains being processed and of supplying and/or exhausting gas such as heated air or the like.

Further another object of the present invention is to provide a powder grain processing technique capable of preventing the coating material from attaching and solidifying, and the solidified coating material from dropping and mixing in the products.

A powder grain processing method of the present invention is one that a powder grain processing method for performing granulating, coating, mixing or drying of powder grains during rotation of a rotary vessel accommodating the powder grains around a horizontal axis thereof, comprises steps of:

providing a agitation means capable of contacting with the powder grains in the rotary vessel wherein the agitation means comprises a support part and agitation parts, the agitation parts being a casing formed by surfaces through which the powder grains are incapable of passing, or a casing having an opening part in a part of the surfaces, in at least an upper surface side thereof and a front side relative to a rotary direction of the rotary vessel; and

processing granulating, coating, mixing or drying of the powder grains together with both granulation and mixture of the powder grains by the agitation means positioned in the powder grains.

In addition, a powder grain processing apparatus is one that a powder grain processing apparatus has a rotary vessel rotated around a horizontal axis thereof and an agitation means inserted into the rotary vessel from a axial direction of the rotary vessel, wherein the agitation means comprises agitation parts for contacting with the powder grains to be agitated and mixed, and a support part for supporting the agitation parts, and wherein the agitation parts are a casing formed by surfaces through which the powder grains are incapable of passing, or a casing having an opening part in a part of the surfaces, in at least an upper surface side thereof and a front side relative to a rotary direction of the rotary vessel.

Because of this means as described above, an effect on agitating contents of tablets or the like is eminently improved in comparison with an agitation means formed in a plate shape or a shape of combining a plurality of plates with one anther. In addition, the powder grain processing apparatus has no dead space in the rotary vessel, and little amount of attachment generated by solidification of a spray liquid and/or powders of the powder grains.

Further, the agitation means having the casing shape has also a function for used as a blowing pipe or a exhausting pipe for supplying or exhausting gas, so that an occupied space for providing the blowing or exhausting pipe decreases in the powder grain processing apparatus and thereby degrees of freedom for installing a spray nozzle increase in the apparatus.

### BRIEF DESCRIPTION OF THE DRAWINGS

FIG. 1 is a front view schematically showing a granulation-coating apparatus which is an embodiment of the present invention.

FIG. 2 is a side view of FIG. 1.

FIG. 3(a) shows an embodiment of agitation means used in the present invention and is a plane view thereof.

FIG. 3(b) shows an embodiment of agitation means used in the present invention and is a side view thereof.

FIG. 3(c) shows an embodiment of agitation means used in the present invention and is a front view thereof.

FIG. 4(a) shows another embodiment of the agitation means used in the present invention and is a side view thereof.

FIG. 4(b) shows another embodiment of the agitation means used in the present invention and is a front view thereof.

FIG. 4(c) shows another embodiment of the agitation means used in the present invention and is a bottom view thereof.

FIG. 5(a) shows further another embodiment of the agitation means used in the present invention and is a side view thereof.

FIG. 5(b) shows further another embodiment of the agitation means used in the present invention and is a front view thereof.

FIG. 5(c) shows further another embodiment of the agitation means used in the present invention and is a bottom view thereof.

FIG. 6(a) shows further another embodiment of the agitation means used in the present invention and is a plane view thereof.

FIG. 6(b) shows further another embodiment of the agitation means used in the present invention and is a side view thereof.

FIG. 6(c) shows further another embodiment of the agitation means used in the present invention and is a front view thereof.

FIG. 6(d) shows further another embodiment of the agitation means used in the present invention and is a bottom view thereof.

FIG. 7(a) shows further another embodiment of the agitation means used in the present invention and is a side view thereof.

FIG. 7(b) shows further another embodiment of the agitation means used in the present invention and is a front view thereof.

FIG. 7(c) shows further another embodiment of the agitation means used in the present invention and is a bottom view thereof.

FIG. 8 is a perspective view showing further another embodiment of the agitation means used in the present invention.

### DESCRIPTION OF THE PREFERRED EMBODIMENTS

(Embodiment 1)

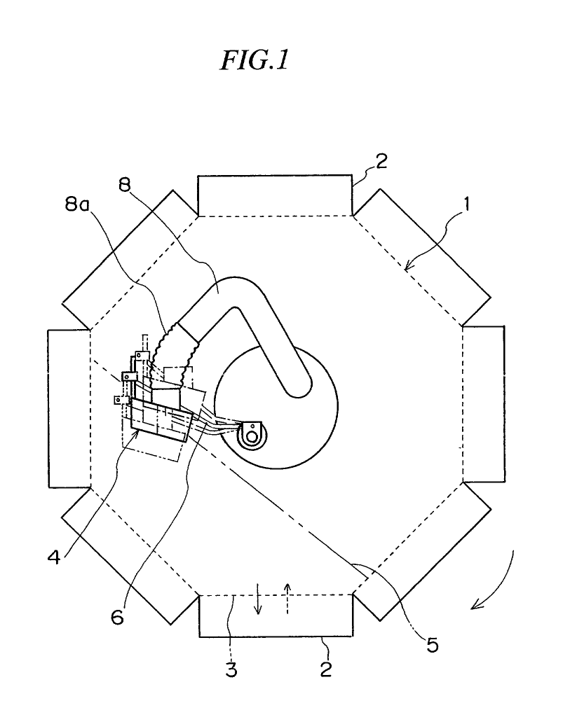

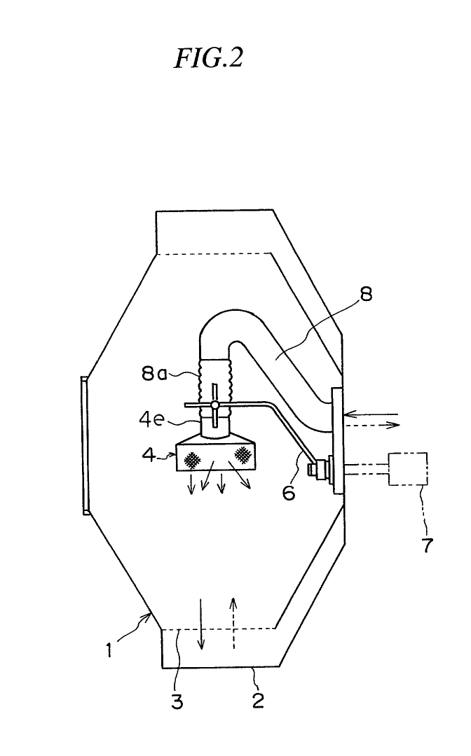

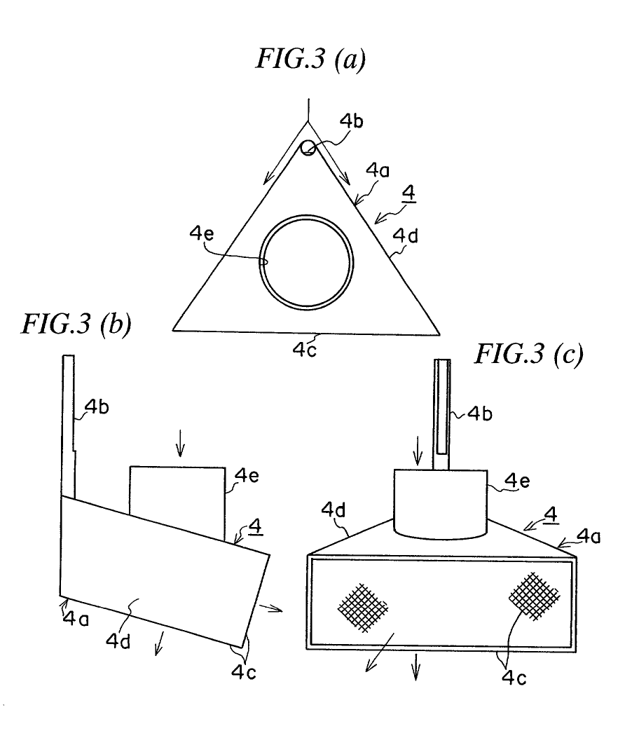

FIG. 1 is a front view schematically showing a granulation-coating apparatus which is an embodiment of the present invention. FIG. 2 is a side view thereof. FIGS. 3(a) to 3(c) show an agitation means used in the present invention, wherein FIGS. 3(a), 3(b) and 3(c) are respectively a plane, a side, and a front view of the agitation means.

The granulation-coating apparatus according to embodiment 1 of the present invention has a rotary vessel 1 formed by a coating pan of an octagonal drum type. This rotary vessel 1 is rotatable around a horizontal rotation axis.

A circumferential wall of the rotary vessel 1 is provided with ducts 2 at eight portions of an outside thereof. The ducts 2 exhaust gas such as heated air, cooled air or the like from an inside of the rotary vessel 1 (as following a down allow with a solid line), or, inversely, supplies heated air or the like into the inside of the rotary vessel 1. Ventilation parts 3 are arranged at the circumferential wall (that is, the entire circumferential wall in the present embodiment) of the rotary vessel 1 as corresponding to positions of the provided ducts 2. Porous parts formed by punching or the like constitute the ventilation parts 3, respectively. A supply and exhaustion structure for supplying or exhausting heated air or the like into or from the rotary vessel 1, and a spray nozzle or the like for supplying a coating liquid are well known in the art (for example, Japanese Patent Application Laid-open No. 7-116227). Therefore, detailed explanation and illustration of both the structure and the nozzle will be omitted from the present specification.

An agitation means 4 for agitating and mixing and the like raw material of powder grains is provided inside the rotary vessel 1. By a hang mechanism not shown, a support bar 6 hangs this agitation means 4 so that the agitation means 4 can be in contact with and agitate and mix a powder grain layer 5.

As shown in FIG. 3(a), the agitation means 4 comprises a hollow casing having a substantially equilateral triangle shape. When the rotary vessel 1 is rotated, the powder grain layer 5 flows as corresponding to the rotation, so that the casing divides flow of the powder grain layer 5 to agitate and mix the powder grain layer 5.

Also, as shown in FIGS. 1 and 2, the agitation means 4 can move between a position (an upper position) indicated by a one-dot-chain line and a position (a lower position) indicated by a two-dot-chain line. Center of the move is a position (a middle position) indicated by a solid line. Accordingly, the agitation means 4 performs the agitating and mixing in contact with the powder grain layer 5 at both the solid-line position and the two-dot-chain-line position. The agitation means 4 locates outside the powder grains layer 5 at the one-dot-chain-line position and, therefore, does not perform the agitating and mixing. In addition, a range of this movable agitation means 4 can be changed in accordance with a preparation amount of powder grains supplied in the rotary vessel 1.

A drive means 7 as a means for driving the agitation means 4 can be arbitrarily selected from among, for example, a rotary actuator and a fluid pressure cylinder which are driven by a fluid pressure, and a motor electrically driven, and the like, as being desired.

Further, the agitation means 4 according to the present embodiment has a hollow casing structure including internally a ventilation passage and comprises agitation parts 4a which contact with the powder grain layer 5 to perform the agitating and mixing, and a support part 4b for linking and supporting a support bar 6. In the agitation parts 4a shown in the example of FIGS. 3(a) to 3(c), a surface (a front surface) in a front side of FIG. 3(c) and a bottom surface of FIG. 3(c) are formed by gas-permeable members 4c like a net material or a porous material. Out of other surfaces except the front and bottom surfaces, at least both surfaces of an upper side thereof, and a front side relative to a rotary direction of the rotary vessel 1, comprise surfaces through which the powder grains do not pass, for example, plate members 4d having no gas-permeability in the present embodiment. The support part 4b projects from a corner of an upstream side of the agitation means 4, that is, of an agitating and mixing side (an upper side of FIG. 3(a)) which is firstly in contact with the flow of the powder grains 5 to divide the flow.

In addition, a vent-pipe connection part 4e provided in the upper surface of the agitation means 4 connects with a vent pipe 8 for supplying or exhausting gas such as heated air, cooled air or the like into or from the agitation means 4. A flexible bellows part 8a as a connection part (a tip part) between the vent pipe 8 and the vent-pipe connection part 4e of the agitation means 4 is provided to be capable of being elastic in accordance with the move of the agitation means 4.

Thus, the agitation means 4 according to the present embodiment has a drying function and/or a cooling function generated by heating the powder grains, in addition to a function of both agitating and mixing the powder grain layer 5.

Operation of the present embodiment will now be explained below.

At first, the raw material of the powder grains for performing the granulation coating is put into the rotary vessel 1. A coating liquid is sprayed into the rotary vessel 1 from a spray nozzle (not shown) while the rotary vessel 1 rotates in a clockwise direction indicated by an arrow shown in FIG. 1.

Meanwhile, at this time, the agitation means 4 is inserted in the powder grain layer 5 as indicated by the two-dot-chain line of FIG. 1, so that, in the rotary vessel 1, heated air (or cooled air if necessary) is supplied through both the ventilation passage and the gas-permeable members 4c inside the agitation means 4 from the vent pipe 8. The heated air passes through the powder grain layer 5 and is exhausted from both the ventilation parts 3 of the rotary vessel 1 and the ducts 2, outside the rotary vessel.

During this granulation-coating operation, the agitation means 4 is inserted in the powder grain layer 5 put into the rotary vessel 1 as indicated by the two-dot-chain line of FIG. 1. The agitation means 4 does not only supply the heated air into the powder gain layer 5 as described above but also both agitates and mixes the powder grain layer 5 as follows. That is, as the rotary vessel 1 rotates, the powder grain layer 5 of the powder grains contacts with the front side, the front surface and the like of the agitation parts 4a and flows along the agitation parts 4a. And, the flow of the powder grains branches into both sides as following two arrows shown in FIG. 3(a), so that the powder grains are agitated and mixed by the agitation means 4.

By the operation described above, granulation or coating of the powder grains is carried out in the powder grain layer 5.

In the present embodiment, the agitation means 4 does not only supply the heated air into the powder grain layer 5 but also both agitates and mixes the powder grains. Therefore, space efficiency is improved because a space for providing the spray nozzle and the like is broad, so that the granulation-coating apparatus can have enough space to provide the spray nozzle and the like.

In addition, since the agitation means 4 is inserted in the powder grain layer 5 at the time of rotating the rotary vessel, the granulation-coating apparatus can efficiently achieve an operation of the granulation coating without a loss of heat in energy.

(Embodiment 2)

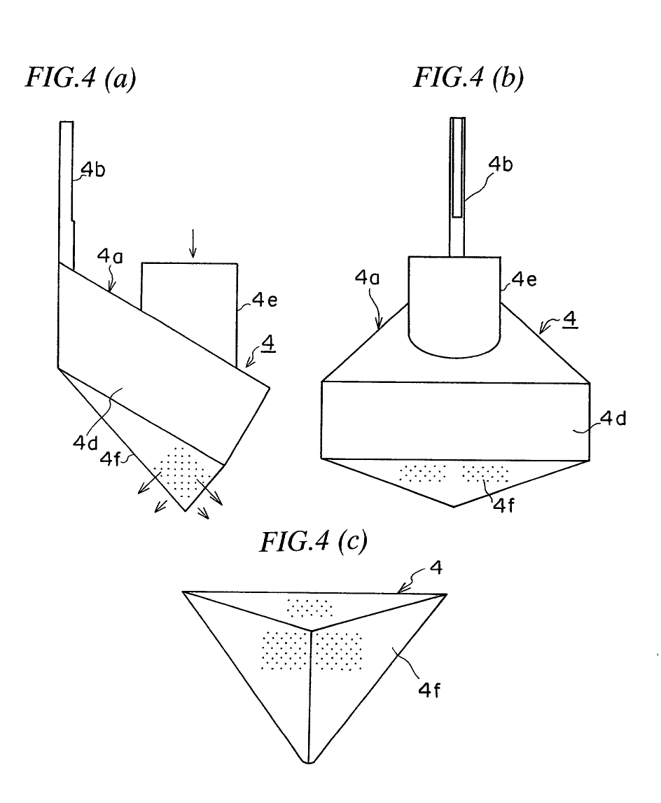

FIGS. 4(a) to (c) show another embodiment of the agitation means used in the present invention, wherein FIGS. 4(a), 4(b) and 4(c) are, respectively, a side, a front, and a bottom view thereof.

In the present embodiment 2, a bottom surface of the agitation parts 4a of the agitation means 4 has a downward projecting structure which projects like a triangular pyramidal shape therefrom. All surfaces of the projecting part having the triangular pyramidal shape comprise gas-permeable members 4f made of, for example, porous materials.

According to this present embodiment 2, the gas-permeable members 4f has the triangular pyramidal projecting structure which projects downward from the bottom surface of a body of the agitation means 4. Therefore, a ventilation area of the triangular pyramidal projecting structure is larger than that of a flat structure of the embodiment 1, so that an amount of gas capable of being ventilated through the gas-permeable members 4f can be increased. In addition, the granulation-coating apparatus can agitate and mix the powder grains not only by the body of the agitation parts 4a of the agitation means 4 but also the projecting parts having the triangular pyramidal shape. Therefore, the granulation-coating apparatus can not only supply efficiently the gas into the powder grain layer 5 but also agitate and mix the powder grains.

(Embodiment 3)

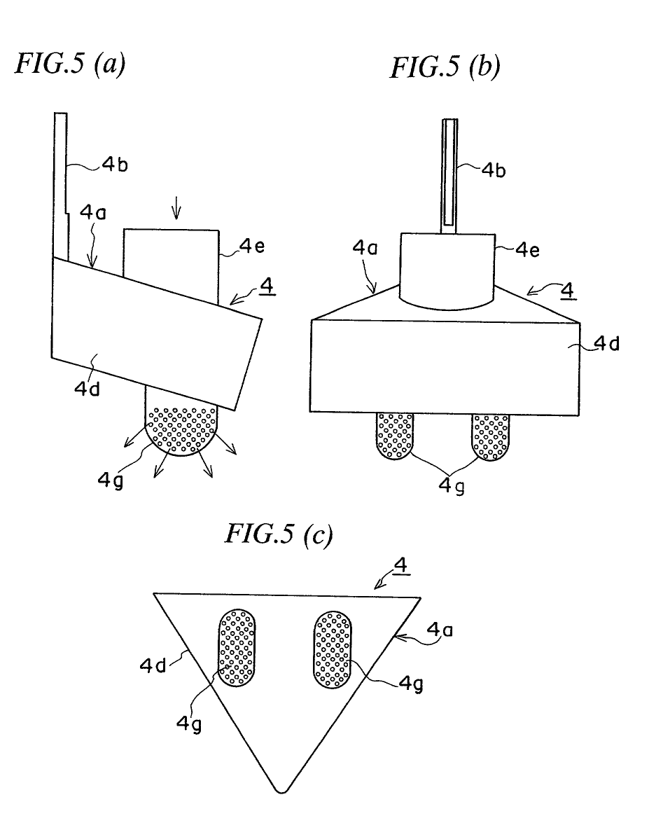

FIGS. 5(a) to 5(c) show still another embodiment of the agitation means used in the present invention, wherein FIGS. 5(a), 5(b) and 5(c) are, respectively, a side, a front, and a bottom view thereof.

In this present embodiment 3, a bottom surface of the agitation parts 4a of the agitation means 4 has, for example, two opening parts formed therein. Each of two gas-permeable members 4g having an elliptic cross-sectional shape is downward projected from the bottom surface around each of the opening parts. Respective gas-permeable members 4g have a ventilation hole formed by a punching means or the like.

Like the embodiment 2, this embodiment 3 too has an advantage capable of achieving an operation for agitating and mixing the powder grains not only by the agitation parts 4a of the agitation means 4 but also by the gas-permeable members 4g themselves.

(Embodiment 4)

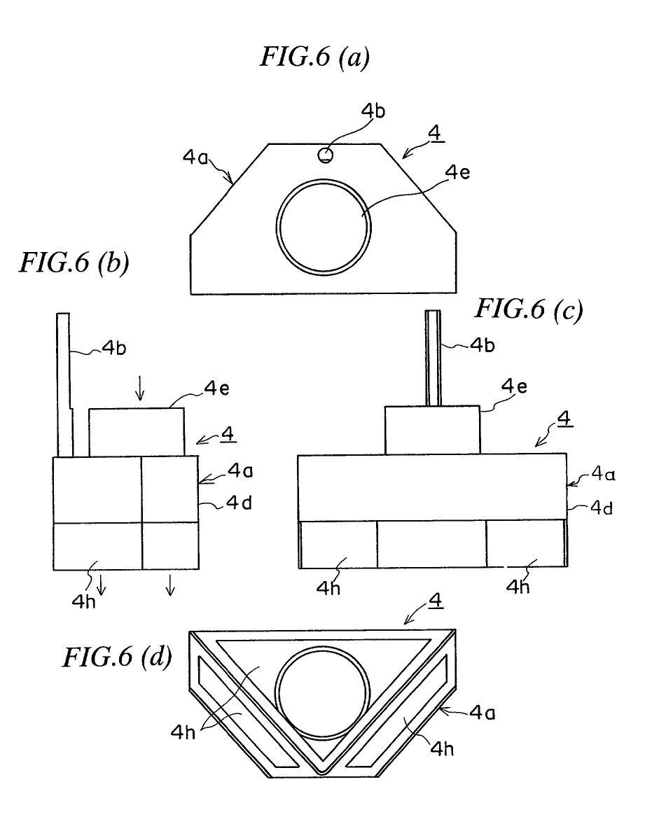

FIGS. 6(a) to (d) show still another embodiment of agitation means used in the present invention, wherein FIGS. 6(a), 6(b), 6(c) and 6(d) are respectively a plane, a side, a front, and a bottom view thereof.

In this present embodiment 4, a body of the agitation parts 4a of the agitation means 4 has such a hexagonal shape that a trapezoid and a rectangle are substantially combined with each other. Additionally, gas-permeable members 4h comprise openings provided with the bottom and side surfaces of the agitation parts 4a of the agitation means 4, respectively.

According to the present embodiment 4, an upstream side of the agitation parts 4a of the agitation means 4, that is, a side for agitating and mixing the flow of the powder grains is formed in a plane defined by a shorter edge of the trapezoid and in both inclined planes located in both sides of the defined-by-a-shorter-edge plane, not in surfaces of a shape having an acute angle like the above-mentioned embodiments 1 to 3. Therefore, the embodiment 4 different from the embodiments 1 to 3 in a structure can obtain a dynamic operation and effect for both agitating and mixing the powder grains.

(Embodiment 5)

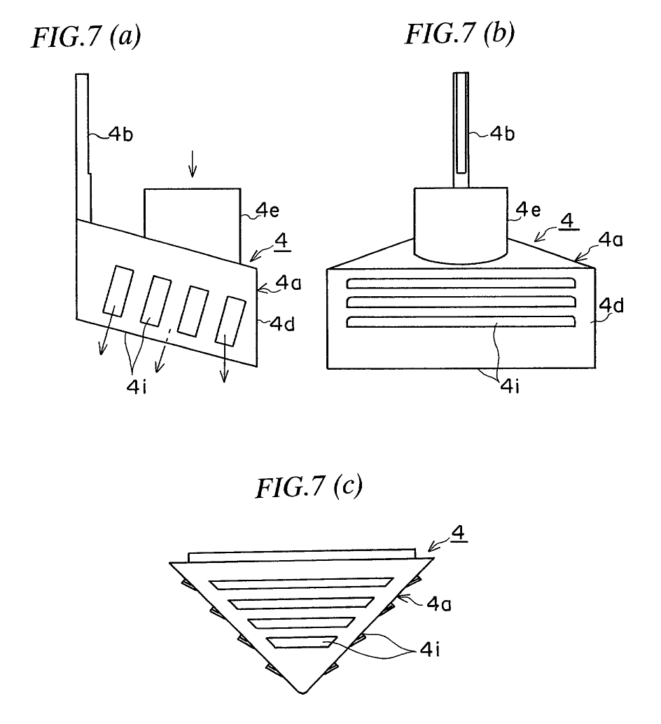

FIGS. 7(a) to 7(c) show further another embodiment of the agitation means used in the present invention, wherein FIGS. 7(a), 7(b) and 7(c) are respectively a side, a front, and a bottom view thereof.

In this present embodiment 5, gas-permeable members 4i of the agitation members 4 comprise long holes and louver-like raised parts. The long holes are provided in both side and bottom surfaces of the agitating means 4. The louver-like raised parts are arranged in the agitation parts 4a of oblique directions and raised by forming the long holes.

In the present embodiment 5, the side and bottom surfaces of the agitation parts 4a of the agitation means 4 do not have smoothly flat surfaces, but have the louver-like raised parts obliquely projected relative to the flow direction of the powder grains. Therefore, agitating and mixing of the powder grains are carried out efficiently.

(Embodiment 6)

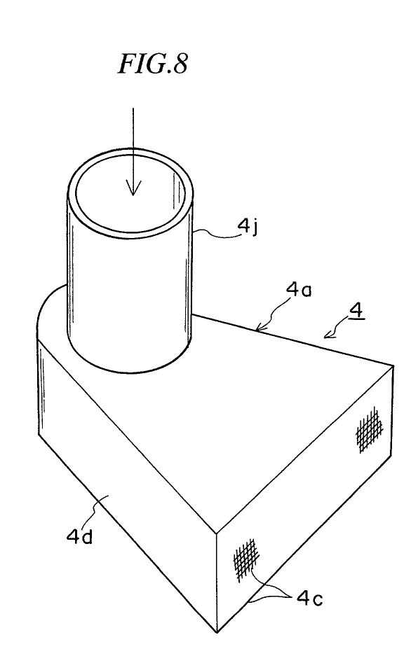

FIG. 8 is a perspective view showing further another embodiment of the agitation means used in the present invention.

In the present embodiment 6, supply of heated air and the like to the ventilation passage of the agitation means 4 is achieved through an internal ventilation passage inside a hollow support part 4j. That is, the support part 4j has two functions of supporting the agitation means 4 and supplying (or exhausting) gas such as heated air and the like to the agitation means 4.

According to this present embodiment 6, the support part 4b and the vent pipe 8 are not provided separately but integrally, unlike the embodiments 1 to 5 described above. Therefore, the embodiment 6 can obtain an advantage in that a structure of the agitation means itself, the support structure thereof, and the gas-supply and gas-exhaustion structure are simplified, respectively.

As described above, the present invention has been explained on the basis of the embodiments. The present invention, however, is not limited to the embodiments described above.

For example, all the surfaces of the rotary vessel 1 need not be formed in a gas-permeable structure, but only a part thereof may be formed in a gas-permeable structure. A rotary vessel having no gas-permeable part may be used in some cases.

In addition, the rotary vessel is not limited to a polygonal shape but may have any other shape such as a circle or the like.

Further, the agitation means 4 can also be used for supply as well as exhaustion of heated air and the like. In case of exhaustion, the supply of heated air and the like is performed, for example, through the ducts 2 or the like.

Also, structures of the agitation means 4 and/or the ventilation type thereof may include other various modifications than those described above. For example, the agitation parts 4a may have a structure of just a casing formed by surfaces through which the powder grains do not pass, or a casing with at least an opening part in a part of the surfaces, in at least an upper surface side thereof and a front side relative to an rotary direction of the rotary vessel 1. Or, for example, the agitation parts 4a may have such a structure that a bottom surface and a rear side of the agitation parts 4a are opened.

Further, it is also possible to adopt a structure in which heated air is supplied or exhausted to or from an opening part of the rotary vessel 1, in addition to the ventilation part of the agitation means 4.

Although the vent pipe 8 connected to the agitation means 4 is provided with the bellows part 8a to obtain flexibility enough to move the agitation means 4, at least a part of the vent pipe 8 may be made of flexible material instead of the bellows part 8a. This can be applied to the support part 4j in the embodiment shown in FIG. 8.

Further, by providing a ventilation hole between both ends of the vent pipe 8 inside the rotary vessel 1, a part of gas or air supplied to the agitation means 4 may be spouted into the rotary vessel 1, not into the powder grain layer 5.

According to the present invention, it is possible to obtain operations and effects as follows.

(1) The agitation parts of the agitation means have a structure of a casing formed by surfaces through which the powder grains do not pass, or a casing having at least an opening part in a part of the surfaces, in at least the upper surface side thereof, and the front side relative to the rotary direction of the rotary vessel. Therefore, at least the upper surface and the front side of the agitation parts contact with the powder grains and thereby the powder grains are rolled, agitated and mixed. So, the agitation means of the present invention can efficiently perform the agitating and mixing of the powder grains in comparison with an agitation means formed only by a plate member or a plurality of plate members.

In addition, the agitation members of the present invention does not have dead spaces therein, so that an attached amount of spray liquid and/or powder which are/is attached to the agitation means can be decreased.

(2) The agitation means can not only agitate and mix the powder grains in the rotary vessel but also supply and/or exhaust gas such as heated air and the like to and/or from the rotary vessel. Therefore, the gas transport pipe does not need to provide the agitation means separated therefrom and an occupied space for providing both gas transport pipe and agitation means in the rotary vessel is reduced. Since other space except the occupied space can be used efficiently, space efficiency is improved, so that the agitation means can have a simple structure.

(3) Due to advantages of the above-described article (2), the gas is efficiently supplied from the agitation means, so that improving the efficiency of energy can be achieved.

(4) Due to advantages of the above-described article (2), it is possible to obtain a large spray region on which the coating liquid spurting from the spray nozzle is scattered.

Also, degrees of freedom to install the spray nozzle are increased.

(5) Due to advantages of the above-described article (4), the coating liquid is prevented from attaching and then solidifying at the agitation means and/or the gas transport pipe. Since the solidified coating liquid is prevented from dropping into and then mixing with the granulation-coating products, the granulation-coating products are not tainted by the coating liquid. Therefore, the granulation-coating products with good quality can be achieved and obtained.

(6) Due to advantages of the above-described articles (1) and (2), a coating efficiency for coating the powder grains can be prevented from reducing.

(7) Due to advantages of the above-described articles (1), (2) and (4), rolling of the powder grains can be maintained in an good condition.

(8) Since ventilation to the agitation means is performed through the internal ventilation passage of the hollow support part thereof, both the support part of the agitation means and the vent pipe can be integrated so that each of the agitation means, the support structure thereof and the gas-supply and exhaustion structure thereof can have a simpler structure.

(9) Since the agitation means can move in the rotary vessel, using in an optimized condition can be performed by changing the preparation amount of powder grains, and changing the position of the agitation means in accordance with the operating purpose such as processing, cleaning or the like.

What is claimed is:

1. A powder grain processing method for performing at least one of granulating, coating, mixing and drying of powder grains during rotation of a rotary vessel accommodating the powder grains around a horizontal axis thereof, the method comprising steps of:
providing a agitation means capable of contacting with the powder grains in the rotary vessel wherein the agitation means comprises a support part and an agitation part, the agitation part being one of a casing formed by surfaces through which the powder grains are incapable of passing, and a casing having an opening part in a part of the surfaces, in at least an upper surface side thereof and a front side relative to a rotary direction of the rotary vessel; and
processing at least one of granulating, coating, mixing and drying of the powder grains together with both granulation and mixture of the powder grains by the agitation means positioned in the powder grains.

2. A powder grain processing apparatus having a rotary vessel rotated around a horizontal axis thereof, and an agitation means inserted into the rotary vessel from a axial direction of the rotary vessel, wherein the agitation means comprises an agitation part for contacting with the powder grains to be agitated and mixed, and a support part for supporting the agitation part, and wherein the agitation part is one of a casing formed by surfaces through which the powder grains are incapable of passing, and a casing having an opening part in a part of the surfaces, in at least an upper surface side thereof and a front side relative to a rotary direction of the rotary vessel.

3. The powder grain processing apparatus according to claim 2, wherein the agitation means connects with a vent pipe which communicates with an inside of the casing, and has such a structure that one of supply and exhaustion is performed from the opening part of the agitation part into the rotary vessel.

4. The powder grain processing apparatus according to claim 2, wherein the opening part of the agitation part is a porous plate through which the powder grains are incapable of passing.

5. The powder grain processing apparatus according to claim 2, wherein ventilation to the agitation means is performed through an inside of the support part of the agitation means.

6. The powder grain processing apparatus according to claim 2, wherein the apparatus has a drive means for moving the agitation means in the rotary vessel.

7. The powder grain processing apparatus according to claim 2, wherein the rotary vessel is capable of being ventilated through a circumferential wall thereof.

8. The powder grain processing apparatus according to claim 2, wherein the agitation means has a gas-permeable member projecting from the agitation part.

9. The powder grain processing apparatus according to claim 3, wherein at least a part of the vent pipe is flexible.

10. The powder grain processing apparatus according to claim 2, wherein the rotary vessel is formed in a polygonal shape.
